(19) United States
(12) Patent Application Publication
(10) Pub. No.: US 2021/0385859 A1
(43) Pub. Date: Dec. 9, 2021

(54) METHOD AND APPARATUS FOR LBT OPTION SELECTION FOR WIDEBAND OPERATION

(71) Applicant: Telefonaktiebolaget LM Ericsson (publ), Stockholm (SE)

(72) Inventors: Jinhua LIU, Beijing (CN); Ming WANG, Luleå (SE)

(21) Appl. No.: 17/288,144

(22) PCT Filed: Sep. 30, 2019
(86) PCT No.: PCT/CN2019/109319

§ 371 Date: Apr. 23, 2021

(30) Foreign Application Priority Data
Oct. 29, 2018 (CN) PCT/CN2018/112429

(51) Int. Cl. H04W 74/00; H04W 74/08; H04W 72/12

(52) U.S. Cl. CPC H04W 74/008; H04W 74/0841; H04W 72/1284; H04W 74/0816

(57) ABSTRACT

Various embodiments of the present disclosure provide a method and apparatus for LBT selection for wideband operation. The method includes determining a configuration of Listen Before Talk (LBT) option selection. The method further includes transmitting the determined configuration of LBT option selection to at least one terminal device.

### FIELD OF THE INVENTION

The present disclosure generally relates to communication networks, and more specifically, to select an LBT option, and transmit according to the selected LBT option.

### BACKGROUND

This section introduces aspects that may facilitate a better understanding of the disclosure. Accordingly, the statements of this section are to be read in this light and are not to be understood as admissions about what is in the prior art or what is not in the prior art.

The next generation systems are expected to support a wide range of use cases with varying requirements ranging from fully mobile devices to stationary IoT or fixed wireless broadband devices. The traffic pattern associated with many use cases is expected to consist of short or long bursts of data traffic with varying length of waiting period in between, which is called inactive state. In order to tackle with the ever-increasing data demanding, the new radio (NR) networks/fifth generation (5G) wireless systems are considered for both licensed and unlicensed spectrum.

In licensed spectrum, the user equipment (UE) measures Reference Signal Received Power (RSRP), and Reference Signal Received Quality (RSRQ) of the downlink radio channel, and provides the measurement reports to its serving eNodeB/gNodeB (eNB/gNB). Besides, the measurements in terms of RSSI are very useful. The RSSI measurements together with the time information concerning when and how long time that UEs have made the measurements can assist the gNB/eNB to detect the hidden node. Additionally, the gNB/eNB can measure the load situation of the carrier which is useful for the network to prioritize some channels for load balance and channel access failure avoidance purposes.

Listen Before Talk (LBT) is designed for unlicensed spectrum co-existence with other Radio Access Technologies (RATs). In this mechanism, a radio device applies a clear channel assessment (CCA) check before any transmission. The transmitter involves energy detection (ED) over a time period compared to a certain threshold (ED threshold) in order to determine if a channel is idle. In case the channel is determined to be occupied, the transmitter performs a random back-off within a contention window before next CCA attempt. In order to protect the Acknowledgement (ACK) transmissions, the transmitter must defer a period after each busy CCA slot prior to resuming back-off. As soon as the transmitter has grasped access to a channel, the transmitter is only allowed to perform transmission up to a maximum time duration, which is called the maximum channel occupancy time (MCOT).

It is expected that NR-Unlicensed (NR-U) will support transmissions over a wide bandwidth, such as much broader than 20 MHz. There are two modes of operation to support wideband transmissions:

Mode 1: Carrier aggregation (CA) based wideband operation analogous to Long Term Evolution-Enhanced Licensed Assisted Access (LTE-eLAA).

Mode 2: Single wideband carrier operation based on a single active bandwidth part (BWP).

For both Mode 1 and 2, there are two possible approaches: (1) sub-band LBT where LBT is performed in units of 20 MHz, and (2) wideband LBT where LBT is performed over the whole schedulable bandwidth. For sub-band LBT, the channel is sensed over a single sub-band of the whole schedulable bandwidth, which is part of the whole schedulable bandwidth. For wideband LBT, the channel is sensed over the entire schedulable bandwidth, and transmission only occurs if the entire schedulable bandwidth is sensed as unoccupied. Based on this, transmission occurs over the entire schedulable bandwidth if LBT is successful, or not at all if LBT fails.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure proposes a solution of choosing LBT option for single carrier wideband operation, especially in unlicensed spectrum, so as to improve the flexibility of the transmission and the system performance.

According to a first aspect of the present disclosure, there is provided a method implemented at a network node. The method may comprise determining a configuration of Listen Before Talk, LBT, option selection. The method may further comprise transmitting the determined configuration of LBT option selection to at least one terminal device.

In accordance with an exemplary embodiment, determining the configuration of LBT selection may comprise: determining the LBT option selection for at least one terminal device; or determining a rule for selecting the LBT option by the terminal device.

In accordance with an exemplary embodiment, each LBT option may be selected for at least one of: a cell, an uplink transmission, a service, a channel.

In accordance with an exemplary embodiment, the LBT option selection may be determined based on at least one of: Buffer Status Report, BSR; Scheduling Request, SR; terminal device category information; terminal device capability information, bandwidth configuration information, bandwidth capacity information, channel sensing information.

In accordance with an exemplary embodiment, the LBT option may be selected for a user data transmission or a control information transmission.

In accordance with an exemplary embodiment, the control information transmission may comprise at least one of: Physical Random Access Channel, PRACH, transmission; Physical Uplink Control Channel, PUCCH, transmission; Sounding Reference Signal, SRS, transmission.

In accordance with an exemplary embodiment, the LBT option may comprise at least one of: wideband LBT, sub-band LBT.

In accordance with an exemplary embodiment, the LBT option may be selected the same as the LBT option of a latest uplink transmission.

In accordance with an exemplary embodiment, the latest uplink transmission information may be stored for a predetermined time.

In accordance with an exemplary embodiment, the sub-band LBT may be selected when any of below criteria is fulfilled: Quality of Service, QoS, requirement for a data in a Logical Channel, LCH, is over a first threshold; Media Access Control, MAC, Protocol Data Unit, PDU, comprises data from at least one of: Uplink Common Control Channel, UL-CCCH; Cell Radio Network Temporary Identifier, C-RNTI, Media Access Control, MAC, Control Element, CE; Buffer Status Report, BSR, CE; Power Headroom Report, PHR, CE; MAC CEs with QoS requirements over a second threshold; scheduled data volume is below a third threshold; scheduled grant occupies a portion of a whole schedulable bandwidth; measured channel occupancy of a whole schedulable bandwidth is over a fourth threshold; a ratio of high loaded sub-bands to all sub-bands occupied a whole schedulable bandwidth is over a fifth threshold, wherein the high loaded sub-bands are the sub-bands with measured channel occupancy of the sub-bands over a sixth threshold; a wideband LBT failure occurs; information to be transmitted is the control information.

In accordance with an exemplary embodiment, the wideband LBT may be selected when none of below criteria is fulfilled: Quality of Service, QoS, requirement for a data in a Logical Channel, LCH, is over a first threshold; Media Access Control, MAC, Protocol Data Unit, PDU, comprises data from at least one of: Uplink Common Control Channel, UL-CCCH; Cell Radio Network Temporary Identifier, C-RNTI, Media Access Control, MAC, Control Element, CE; Buffer Status Report, BSR, CE; Power Headroom Report, PHR, CE; MAC CEs with QoS requirements over a second threshold; scheduled data volume is below a third threshold; scheduled grant occupies a portion of a whole schedulable bandwidth; measured channel occupancy of a whole schedulable bandwidth is over a fourth threshold; a ratio of high loaded sub-bands to all sub-bands occupied a whole schedulable bandwidth is over a fifth threshold, wherein the high loaded sub-bands are the sub-bands with measured channel occupancy of the sub-bands over a sixth threshold; a wideband LBT failure occurs; information to be transmitted is the control information.

In accordance with an exemplary embodiment, the wideband LBT is selected when all sub-bands are determined to be available for an uplink transmission.

In accordance with an exemplary embodiment, the method according to the first aspect of the present disclosure may further comprise receiving a channel sensing information from the terminal device.

In accordance with an exemplary embodiment, the channel sensing information may comprise a received power strength per sub-band of a Bandwidth Part, BWP, and/or a total received power in the whole scheduled bandwidth.

In accordance with an exemplary embodiment, transmitting the determined configuration of LBT option selection to at least one terminal device may comprise transmitting the determined configuration of LBT option selection to at least one terminal device via at least one of: System Information Block, SIB, signaling; Downlink Control Information, DCI, signaling; Media Access Control, MAC, Control Element, CE; Radio Resource Control, RRC, signaling.

According to a second aspect of the present disclosure, there is provided an apparatus implemented in a network node. The apparatus comprises one or more processors and one or more memories comprising computer program codes. The one or more memories and the computer program codes are configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus implemented in a network node. The apparatus comprises a determining module and a transmitting module. In accordance with some exemplary embodiments, the determining module is operable to carry out at least the determining step of the method according to the first aspect of the present disclosure. The transmitting module is operable to carry out at least the transmitting step of the method according to the first aspect of the present disclosure.

According to a fifth aspect of the present disclosure, there is provided a method implemented at a terminal device. The method may comprise receiving a configuration of Listen Before Talk, LBT, option selection from at least one network node. The method may further comprise obtaining the configuration of LBT option selection.

In accordance with an exemplary embodiment, obtaining the configuration of LBT selection may comprise: obtaining the LBT option selection determined by the network node for the terminal device; or obtaining a rule for selecting the LBT option by the terminal device.

In accordance with an exemplary embodiment, each LBT option may be selected for at least one of: a cell, an uplink transmission, a service, a channel.

In accordance with an exemplary embodiment, the LBT option selection may be determined based on at least one of: Buffer Status Report, BSR; Scheduling Request, SR; terminal device category information; terminal device capability information, bandwidth configuration information, bandwidth capacity information, channel sensing information.

In accordance with an exemplary embodiment, the LBT option may be selected for a user data transmission or a control information transmission.

In accordance with an exemplary embodiment, the control information transmission may comprise at least one of: Physical Random Access Channel, PRACH, transmission; Physical Uplink Control Channel, PUCCH, transmission; Sounding Reference Signal, SRS, transmission.

In accordance with an exemplary embodiment, the LBT option may comprise at least one of: wideband LBT, sub-band LBT.

In accordance with an exemplary embodiment, the LBT option may be selected the same as the LBT option of a latest uplink transmission.

In accordance with an exemplary embodiment, the latest uplink transmission information may be stored for a predetermined time.

In accordance with an exemplary embodiment, the sub-band LBT may be selected when any of below criteria is fulfilled: Quality of Service, QoS, requirement for a data in a Logical Channel, LCH, is over a first threshold; Media Access Control, MAC, Protocol Data Unit, PDU, comprises data from at least one of: Uplink Common Control Channel, UL-CCCH; Cell Radio Network Temporary Identifier, C-RNTI, Media Access Control, MAC, Control Element, CE; Buffer Status Report, BSR, CE; Power Headroom Report, PHR, CE; MAC CEs with QoS requirements over a second threshold; scheduled data volume is below a third threshold; scheduled grant occupies a portion of a whole schedulable bandwidth; measured channel occupancy of a whole schedulable bandwidth is over a fourth threshold; a ratio of high loaded sub-bands to all sub-bands occupied a whole schedulable bandwidth is over a fifth threshold, wherein the high loaded sub-bands are the sub-bands with measured channel occupancy of the sub-bands over a sixth threshold; a wideband LBT failure occurs; information to be transmitted is the control information.

In accordance with an exemplary embodiment, the wideband LBT may be selected when none of below criteria is fulfilled: Quality of Service, QoS, requirement for a data in a Logical Channel, LCH, is over a first threshold; Media Access Control, MAC, Protocol Data Unit, PDU, comprises data from at least one of: Uplink Common Control Channel, UL-CCCH; Cell Radio Network Temporary Identifier, C-RNTI, Media Access Control, MAC, Control Element, CE; Buffer Status Report, BSR, CE; Power Headroom Report, PHR, CE; MAC CEs with QoS requirements over a second threshold; scheduled data volume is below a third threshold; scheduled grant occupies a portion of a whole schedulable bandwidth; measured channel occupancy of a whole schedulable bandwidth is over a fourth threshold; a ratio of high loaded sub-bands to all sub-bands occupied a whole schedulable bandwidth is over a fifth threshold, wherein the high loaded sub-bands are the sub-bands with measured channel occupancy of the sub-bands over a sixth threshold; a wideband LBT failure occurs; information to be transmitted is the control information.

In accordance with an exemplary embodiment, the wideband LBT may be selected when all sub-bands are determined to be available for an uplink transmission.

In accordance with an exemplary embodiment, the method according to the fifth aspect of the present disclosure may further comprise transmitting a channel sensing information from the terminal device.

In accordance with an exemplary embodiment, the channel sensing information may further comprise a received power strength per sub-band of a Bandwidth Part, BWP, and/or a total received power in the whole scheduled bandwidth.

In accordance with an exemplary embodiment, receiving a configuration of LBT option selection from at least one network node may comprise receiving a configuration of LBT option selection from at least one network node via at least one of: System Information Block, SIB, signaling; Downlink Control Information, DCI, signaling; Media Access Control, MAC, Control Element, CE; Radio Resource Control, RRC, signaling.

In accordance with an exemplary embodiment, the method according to the first aspect of the present disclosure may further comprise applying the selected LBT option after obtaining the LBT option selection determined by the network node, or after selecting the LBT option according to the rule received from the network node.

According to a sixth aspect of the present disclosure, there is provided an apparatus implemented in a terminal device. The apparatus comprises one or more processors and one or more memories comprising computer program codes. The one or more memories and the computer program codes are configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus implemented in a terminal device. The apparatus comprises a receiving module and an obtaining module. In accordance with some exemplary embodiments, the receiving module is operable to carry out at least the receiving step of the method according to the fifth aspect of the present disclosure. The obtaining module is operable to carry out at least the obtaining step of the method according to the fifth aspect of the present disclosure.

According to a ninth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the fifth aspect of the present disclosure.

According to a tenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fifth aspect of the present disclosure.

According to an eleventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to a twelfth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first aspect of the present disclosure.

According to a thirteenth aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a fourteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

According to a fifteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fifth aspect of the present disclosure.

According to a sixteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fifth aspect of the present disclosure.

With above aspects of the present disclosure, the network node has the ability to select or determine the rule for the terminal device to select which LBT option to use, therefore both advantages of sub-band LBT and wideband LBT can be taken, and the flexibility of the transmission and the system performance can be improved.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating sub-band LBT and wideband LBT in a wideband carrier operation based on Carrier aggregation of Mode 1 and a single active bandwidth part of Mode 2;

FIG. 2 is a flowchart illustrating a method according to some embodiments of the present disclosure;

FIG. 3 is a flowchart illustrating another method according to some embodiments of the present disclosure;

FIG. 4 is a block diagram illustrating an apparatus according to some embodiments of the present disclosure;

FIG. 5 is a block diagram illustrating another apparatus according to some embodiments of the present disclosure;

FIG. 6 is a block diagram illustrating yet another apparatus according to some embodiments of the present disclosure;

FIG. 7 is a block diagram illustrating yet another apparatus according to some embodiments of the present disclosure;

FIG. 8 is a block diagram illustrating a telecommunication network connected via an intermediate network to a host computer in accordance with some embodiments of the present disclosure;

FIG. 9 is a block diagram illustrating a host computer communicating via a base station with a UE over a partially wireless connection in accordance with some embodiments of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure;

FIG. 12 is a flowchart illustrating a method implemented in a communication system, in accordance with an embodiment of the present disclosure; and

FIG. 13 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like. In the following description, terms “terminal device” and “UE” will be used interchangeably.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

The below embodiments are described in the context of NR unlicensed spectrum (NR-U). However, they are not limited to NR-U scenarios. They are also applicable to other operation scenarios, such as unlicensed LTE Licensed Assisted Access/Enhanced Licensed Assisted Access (LAA/eLAA).

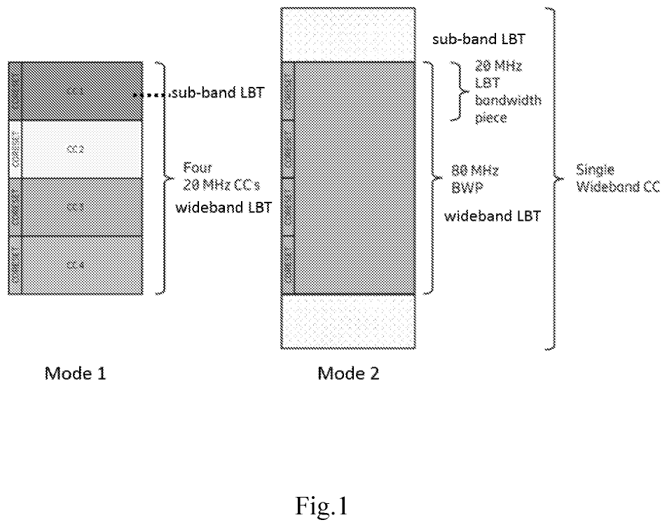

FIG. 1 is a diagram illustrating sub-band LBT and wideband LBT in a wideband carrier operation based on Carrier aggregation of Mode 1 and a single active bandwidth part of Mode 2.

As shown in FIG. 1, Mode 1 is for the Carrier aggregation (CA) based wideband operation analogous to Long Term Evolution-Enhanced Licensed Assisted Access (LTE-eLAA). As an example, there are four component carriers (CCs) totaling 80 MHz which are activated prior to reception/transmission, the bandwidth for each of which is 20 MHz, which is also an example. Actually, the number of the CCs to aggregate as a whole schedulable bandwidth and the bandwidth for each CC can be any number suitable for the system. In such situation, the sub-band LBT can be performed for each CC, and the wideband LBT can be performed for the aggregated CCs. Mode 2 is for a single wideband carrier operation based on a single active bandwidth part (BWP). As an example, the UE is configured with a single 80 MHz bandwidth part (BWP) which is assumed activated prior to reception/transmission. And there are four bandwidth pieces in the BWP, the bandwidth for each of which is 20 MHz, which is also an example. Actually, the number of the bandwidth pieces to form a whole schedulable bandwidth, which is the BWP here, and the bandwidth for each bandwidth piece and the BWP can be any number suitable for the system. In such situation, the sub-band LBT can be performed for each bandwidth piece, and the wideband LBT can be performed for the whole schedulable bandwidth, which is the BWP here.

The sub-band LBT may give better flexibility of the grant usage to the UE especially when there is unbalanced load distribution between sub-bands. In this case, it may be difficult for the UE to occupy the full bandwidth. If the UE chooses the wideband LBT, the UE may have high probability to experience LBT failures, the UE then has to drop the Media Access Control (MAC) Protocol Data Unit (PDU), which would affect the QoS satisfaction for services. If there is Ultra-Reliable Low-Latency Communication (URLLC) service, the drop of MAC PDU and incurred additional latency due to higher layer retransmission is not acceptable.

For wideband LBT, the channel is sensed over the entire schedulable bandwidth, and transmission only occurs if the entire schedulable bandwidth is sensed as unoccupied. Based on this, transmission occurs over the entire schedulable bandwidth if LBT is successful, or not at all if LBT fails. In contrast to sub-band LBT, since for wideband LBT, the UE or gNB transmits the data only in case the LBT succeeds over the full bandwidth. So, if there is a LBT failure, the UE or gNB doesn't transmit, or even drop the data. Therefore, the wideband LBT avoids the puncturing/rate matching issues and the guard band issues, but the flexibility of the grant usage to the UE may be bad, as described above.

As described above, both sub-band LBT and wideband LBT may be suitable for some kinds of scenarios, but not to all the scenarios. If one of them is used permanently, it may damage to the system performance. Therefore it is needed to define rules on how to decide which LBT option shall be applicable in different scenarios.

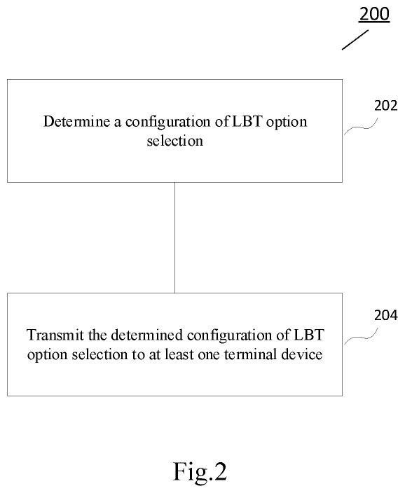

FIG. 2 is a flowchart illustrating a method 200 according to some embodiments of the present disclosure. The method 200 illustrated in FIG. 2 may be performed by an apparatus implemented in a network node or communicatively coupled to a network node.

According to the exemplary method 200 illustrated in FIG. 2, the network node such as an eNodeB (eNB) or a gNodeB (gNB) can determine a configuration of Listen Before Talk (LBT) option selection, as shown in block 202.

In accordance with an exemplary embodiment, the network node may determine the LBT option selection for one or more terminal devices, which means the network node will select the LBT option, such as the sub-band LBT or the wideband LBT or both of them, for the terminal device(s).

In accordance with an exemplary embodiment, the network node may also determine a rule for the one or more terminal devices to let them select the LBT option, such as the sub-band LBT or the wideband LBT or both of them, by their own.

In accordance with another exemplary embodiment, each LBT option can be selected for a cell. In such case, all the terminal devices within the cell will use the same LBT option, and terminal devices in another cell may use another LBT option.

In accordance with another exemplary embodiment, each LBT option can be selected for every uplink transmission. That means different uplink transmissions may be applied with different LBT options.

In accordance with another exemplary embodiment, each LBT option can be selected for a service. That means different services may be applied with different LBT options.

In accordance with another exemplary embodiment, each LBT option can be selected for a channel. That means different channels may be applied with different LBT options.

In accordance with another exemplary embodiment, the network node or the terminal device may select the LBT option based on any of below information: the Buffer Status Report (BSR) received or generating from the terminal device; the Scheduling Request (SR) received or generating from the terminal device; the terminal device category information; the terminal device capability information, the bandwidth configuration information, the bandwidth capacity information, and channel sensing information.

In accordance with another exemplary embodiment, each LBT option can be selected for the user data transmission, such as the URLLC data transmission.

In accordance with another exemplary embodiment, each LBT option can also be selected for the control information transmission, such as the Physical Random Access Channel (PRACH) transmission, the Physical Uplink Control Channel (PUCCH) transmission, the Sounding Reference Signal (SRS) transmission.

In accordance with another exemplary embodiment, when there are some uplink transmissions, the network node or the terminal device may tend to select the same LBT option for the upcoming uplink transmission as the LBT option for the latest uplink transmission. In such case, the historic information may be stored or valid for a specific time period, such as configured by a timer. When there is longer time period (than the timer) elapsed since the latest uplink transmission, the terminal device applies the LBT option configured by the network or the one determined by the terminal device based on the rules specified by the network node.

In accordance with another exemplary embodiment, the sub-band LBT can be selected when any of below criteria is fulfilled:

the Quality of Service (QoS) requirement for a data in a Logical Channel (LCH) is over a first threshold, which means there is data from LCH with critical QoS requirements, so that the data transmission is prone to the packet loss or latency;

the Media Access Control (MAC) Protocol Data Unit (PDU) comprises data from at least one of: Uplink Common Control Channel (UL-CCCH), Cell Radio Network Temporary Identifier (C-RNTI) Media Access Control (MAC) Control Element (CE), Buffer Status Report (BSR) CE, Power Headroom Report (PHR) CE, MAC CEs with QoS requirements over a second threshold, which means there is control information with critical QoS requirements, so that the control information transmission is prone to the packet loss or latency;

the scheduled data volume is below a third threshold, so that the scheduled grant occupies a portion of the whole schedulable bandwidth;

the scheduled grant occupies a portion of a whole schedulable bandwidth;

the measured channel occupancy of a whole schedulable bandwidth is over a fourth threshold; for the above case, the terminal device may have high risk to occur LBT failure for wideband LBT option;

the ratio of high loaded sub-bands to all sub-bands occupied a whole schedulable bandwidth is over a fifth threshold, wherein the high loaded sub-bands are the sub-bands with measured channel occupancy of the sub-bands over a sixth threshold; in such case, the channel occupancy is measured per sub-band; an predefined threshold is defined to determine if the sub-band is highly loaded, in case the measured channel occupancy of the associated sub-band is over that threshold, therefore, the ratio of high loaded/channel occupied sub-bands is over yet another predefined threshold; for the above case, the terminal device may have high risk to occur LBT failure for wideband LBT option;

a wideband LBT failure occurs; in such case, a terminal device turns to use sub-band LBT to sense every scheduled sub-band when the previous wideband LBT fails; in this way, the terminal device can still use the available sub-bands for data transmission, and may transmit parts of the MAC PDU by skipping some parts or transmit with proper puncturing;

the information to be transmitted is the control information, such as the Physical Random Access Channel (PRACH), the Physical Uplink Control Channel (PUCCH), the Sounding Reference Signal (SRS); as an example, it can be predefined that only sub-band LBT is applied for any of PRACH, PUCCH and SRS transmission; as another example, a terminal device is configured/allowed to determine the LBT option for SRS transmission based on one of the similar rules as aforenoted embodiments.

In accordance with another exemplary embodiment, the wideband LBT can be selected when none of below criteria is fulfilled:

the Quality of Service (QoS) requirement for a data in a Logical Channel (LCH) is over a first threshold;

the Media Access Control (MAC) Protocol Data Unit (PDU) comprises data from at least one of: Uplink Common Control Channel (UL-CCCH), Cell Radio Network Temporary Identifier (C-RNTI) Media Access Control (MAC) Control Element (CE), Buffer Status Report (BSR) CE, Power Headroom Report (PHR) CE, MAC CEs with QoS requirements over a second threshold;

the scheduled data volume is below a third threshold;

the scheduled grant occupies a portion of a whole schedulable bandwidth;

the measured channel occupancy of a whole schedulable bandwidth is over a fourth threshold;

a ratio of high loaded sub-bands to all sub-bands occupied a whole schedulable bandwidth is over a fifth threshold, wherein the high loaded sub-bands are the sub-bands with measured channel occupancy of the sub-bands over a sixth threshold;

a wideband LBT failure occurs;

the information to be transmitted is the control information;

which means when it is not proper to use the sub-band LBT, then the wideband LBT can be selected.

In accordance with another exemplary embodiment, the wideband LBT can be selected when all sub-bands are determined to be available for an uplink transmission, especially when all sub-bands were determined to be available for the latest uplink transmissions. In such case, the historic information may be stored or valid for a specific time period, such as configured by a timer. When there is longer time period (than the timer) elapsed since the latest uplink transmission, the terminal device applies the LBT option configured by the network or the one determined by the terminal device based on the rules specified by the network node.

According to the exemplary method 200 illustrated in FIG. 2, the network node such as an eNodeB (eNB) or a gNodeB (gNB) can transmit the determined configuration of LBT option selection to at least one terminal device, as shown in block 204.

In accordance with another exemplary embodiment, the network node may transmit the determined configuration of LBT option selection to at least one terminal device via any one of: System Information Block (SIB) signaling; Downlink Control Information (DCI) signaling; Media Access Control (MAC) Control Element (CE); Radio Resource Control (RRC) signaling.

According to the exemplary method 200 illustrated in FIG. 2, the network node such as an eNodeB (eNB) or a gNodeB (gNB) can further receive the channel sensing information from the terminal device.

In accordance with another exemplary embodiment, the channel sensing information may comprise a received power strength per sub-band of a Bandwidth Part (BWP) and/or a total received power in the whole scheduled bandwidth. With such information from the terminal device, the network node can configure or reconfigure the LBT option for the terminal device.

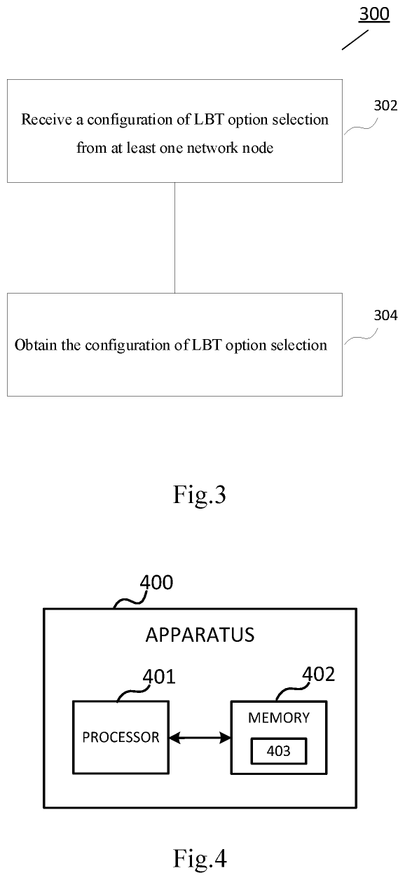

FIG. 3 is a flowchart illustrating a method 300 according to some embodiments of the present disclosure. As described in connection with FIG. 2, the method 300 illustrated in FIG. 3 may be performed by an apparatus implemented in a terminal device or communicatively coupled to a terminal device. In accordance with an exemplary embodiment, the terminal device such as a UE may receive a configuration of Listen Before Talk (LBT) option selection from at least one network node, as shown in block 302.

According to the exemplary method 300 illustrated in FIG. 3, the terminal device such as a UE may further obtain the configuration of LBT option selection, as shown in block 304.

In accordance with another exemplary embodiment, the terminal device may receive the configuration of LBT option selection from at least one network node via any one of: System Information Block (SIB) signaling; Downlink Control Information (DCI) signaling; Media Access Control (MAC) Control Element (CE); Radio Resource Control (RRC) signaling.

In accordance with an exemplary embodiment, the terminal device may obtain the LBT option selection determined by the network node for the terminal device, which means the network node will select the LBT option, such as the sub-band LBT or the wideband LBT or both of them, for the terminal device(s), and the terminal device can receive the determination and obtain the LBT selection.

In accordance with an exemplary embodiment, the terminal device may also obtain a rule for selecting the LBT option, such as the sub-band LBT or the wideband LBT or both of them, by its own. In such case, the network node will determine the rule for the terminal device for selecting the LBT options, and the terminal device can receive the determination and select the LBT selection according to the rule.

In accordance with another exemplary embodiment, each LBT option can be selected for a cell. In such case, all the terminal devices within the cell will use the same LBT option, and terminal devices in another cell may use another LBT option.

In accordance with another exemplary embodiment, each LBT option can be selected for every uplink transmission. That means different uplink transmissions may be applied with different LBT options.

In accordance with another exemplary embodiment, each LBT option can be selected for a service. That means different services may be applied with different LBT options.

In accordance with another exemplary embodiment, each LBT option can be selected for a channel. That means different channels may be applied with different LBT options.

In accordance with another exemplary embodiment, the network node or the terminal device may select the LBT option based on any of below information: the Buffer Status Report (BSR) received or generating from the terminal device; the Scheduling Request (SR) received or generating from the terminal device; the terminal device category information; the terminal device capability information, the bandwidth configuration information, the bandwidth capacity information, and channel sensing information.

In accordance with another exemplary embodiment, each LBT option can be selected for the user data transmission, such as the URLLC data transmission.

In accordance with another exemplary embodiment, each LBT option can also be selected for the control information transmission, such as the Physical Random Access Channel (PRACH) transmission, the Physical Uplink Control Channel (PUCCH) transmission, the Sounding Reference Signal (SRS) transmission.

In accordance with another exemplary embodiment, when there are some uplink transmissions, the network node or the terminal device may tend to select the same LBT option for the upcoming uplink transmission as the LBT option for the latest uplink transmission. In such case, the historic information may be stored or valid for a specific time period, such as configured by a timer. When there is longer time period (than the timer) elapsed since the latest uplink transmission, the terminal device applies the LBT option configured by the network or the one determined by the terminal device based on the rules specified by the network node.

In accordance with another exemplary embodiment, the sub-band LBT can be selected when any of below criteria is fulfilled:

the Quality of Service (QoS) requirement for a data in a Logical Channel (LCH) is over a first threshold, which means there is data from LCH with critical QoS requirements, so that the data transmission is prone to the packet loss or latency;

the Media Access Control (MAC) Protocol Data Unit (PDU) comprises data from at least one of: Uplink Common Control Channel (UL-CCCH), Cell Radio Network Temporary Identifier (C-RNTI) Media Access Control (MAC) Control Element (CE), Buffer Status Report (BSR) CE, Power Headroom Report (PHR) CE, MAC CEs with QoS requirements over a second threshold, which means there is control information with critical QoS requirements, so that the control information transmission is prone to the packet loss or latency;

the scheduled data volume is below a third threshold, so that the scheduled grant occupies a portion of the whole schedulable bandwidth;

the scheduled grant occupies a portion of a whole schedulable bandwidth;

the measured channel occupancy of a whole schedulable bandwidth is over a fourth threshold; for the above case, the terminal device may have high risk to occur LBT failure for wideband LBT option;

the ratio of high loaded sub-bands to all sub-bands occupied a whole schedulable bandwidth is over a fifth threshold, wherein the high loaded sub-bands are the sub-bands with measured channel occupancy of the sub-bands over a sixth threshold; in such case, the channel occupancy is measured per sub-band; an predefined threshold is defined to determine if the sub-band is highly loaded, in case the measured channel occupancy of the associated sub-band is over that threshold, therefore, the ratio of high loaded/channel occupied sub-bands is over yet another predefined threshold; for the above case, the terminal device may have high risk to occur LBT failure for wideband LBT option;

a wideband LBT failure occurs; in such case, a terminal device turns to use sub-band LBT to sense every scheduled sub-band when the previous wideband LBT fails; in this way, the terminal device can still use the available sub-bands for data transmission, and may transmit parts of the MAC PDU by skipping some parts or transmit with proper puncturing;

the information to be transmitted is the control information, such as the Physical Random Access Channel (PRACH), the Physical Uplink Control Channel (PUCCH), the Sounding Reference Signal (SRS); as an example, it can be predefined that only sub-band LBT is applied for any of PRACH, PUCCH and SRS transmission; as another example, a terminal device is configured/allowed to determine the LBT option for SRS transmission based on one of the similar rules as aforenoted embodiments.

In accordance with another exemplary embodiment, the wideband LBT can be selected when none of below criteria is fulfilled:

the Quality of Service (QoS) requirement for a data in a Logical Channel (LCH) is over a first threshold;

the Media Access Control (MAC) Protocol Data Unit (PDU) comprises data from at least one of: Uplink Common Control Channel (UL-CCCH), Cell Radio Network Temporary Identifier (C-RNTI) Media Access Control (MAC) Control Element (CE), Buffer Status Report (BSR) CE, Power Headroom Report (PHR) CE, MAC CEs with QoS requirements over a second threshold;

the scheduled data volume is below a third threshold;

the scheduled grant occupies a portion of a whole schedulable bandwidth;

the measured channel occupancy of a whole schedulable bandwidth is over a fourth threshold;

a ratio of high loaded sub-bands to all sub-bands occupied a whole schedulable bandwidth is over a fifth threshold, wherein the high loaded sub-bands are the sub-bands with measured channel occupancy of the sub-bands over a sixth threshold;

a wideband LBT failure occurs;

the information to be transmitted is the control information;

which means when it is not proper to use the sub-band LBT, then the wideband LBT can be selected.

In accordance with another exemplary embodiment, the wideband LBT can be selected when all sub-bands are determined to be available for an uplink transmission, especially when all sub-bands were determined to be available for the latest uplink transmissions. In such case, the historic information may be stored or valid for a specific time period, such as configured by a timer. When there is longer time period (than the timer) elapsed since the latest uplink transmission, the terminal device applies the LBT option configured by the network or the one determined by the terminal device based on the rules specified by the network node.

According to the exemplary method 300 illustrated in FIG. 3, the terminal device such as a UE can further transmit a channel sensing information from the terminal device.

In accordance with another exemplary embodiment, the channel sensing information may comprise a received power strength per sub-band of a Bandwidth Part (BWP) and/or a total received power in the whole scheduled bandwidth. With such information from the terminal device, the network node can configure or reconfigure the LBT option for the terminal device.

According to the exemplary method 300 illustrated in FIG. 3, the terminal device such as a UE can further apply the selected LBT option after obtaining the LBT option selection determined by the network node, or after selecting the LBT option according to the rule received from the network node. Upon reception of the message or signaling from the network node, the terminal device may apply the LBT option, such as the sub-band LBT or the wideband LBT prior to the corresponding Physical Uplink Shared Channel (PUSCH) transmission.

It will be realized that parameters, variables and settings related to the determination, transmission, obtaining and reception described herein are just examples. Other suitable network settings, the associated configuration parameters and the specific values thereof may also be applicable to implement the proposed methods.

The proposed solution according to one or more exemplary embodiments can make the network node has the ability to select or determine the rule for the terminal device to select which LBT option to use, therefore both advantages of sub-band LBT and wideband LBT can be taken, and the flexibility of the transmission and the system performance can be improved.

The various blocks shown in FIG. 2 and FIG. 3 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

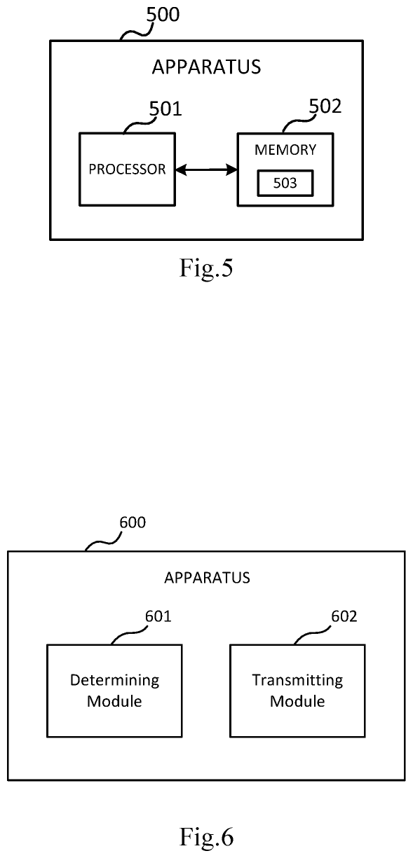

FIG. 4 and FIG. 5 are block diagrams illustrating an apparatus 400 and 500 according to various embodiments of the present disclosure. As shown in FIG. 4 and FIG. 5, the apparatus 400 may be implemented in or as a network node, while the apparatus 500 may be implemented in or as a terminal device. The apparatus 400 or 500 may comprise one or more processors such as processor 401 or 501, and one or more memories such as memory 402 or 502, storing computer program codes 403 or 503. The memory 402 or 502 may be non-transitory machine/processor/computer readable storage medium. In accordance with some exemplary embodiments, the apparatus 400 or 500 may be implemented as an integrated circuit chip or module that can be plugged or installed into a network node as described with respect to FIG. 2, or a terminal device as described with respect to FIG. 3.

In some implementations, the one or more memories 402 or 502, and the computer program codes 403 or 503, may be configured to, with the one or more processors 401 or 501, cause the apparatus 400 or 500 at least to perform any operation of the method as described in connection with FIG. 2 or FIG. 3. In other implementations, the one or more memories 402 or 502, and the computer program codes 403 or 503, may be configured to, with the one or more processors 401 or 501, cause the apparatus 400 or 500 at least to perform any operation of the method as described in connection with FIG. 2 or FIG. 3.

FIG. 6 is a block diagram illustrating an apparatus 600 according to some embodiments of the present disclosure. As shown in FIG. 6, the apparatus 600 may comprise a determining module 601 and a transmitting module 602. In an exemplary embodiment, the apparatus 600 may be implemented in a network node such as a eNB or gNB. The determining module 601 may be operable to carry out the operation in block 202, and the transmitting module 602 may be operable to carry out the operation in block 204. Optionally, the determining module 601 and/or the transmitting module 602 may be operable to carry out more or less operations to implement the proposed methods according to the exemplary embodiments of the present disclosure.

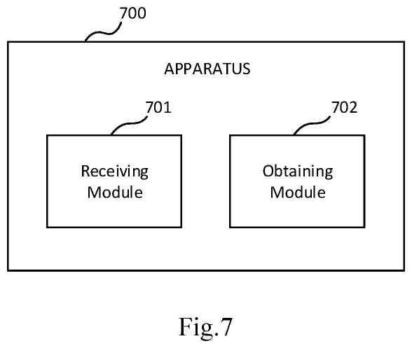

FIG. 7 is a block diagram illustrating an apparatus 700 according to some embodiments of the present disclosure. As shown in FIG. 7, the apparatus 700 may comprise a receiving module 70 and an obtaining module 702. In an exemplary embodiment, the apparatus 700 may be implemented in a terminal device such as a UE. The receiving module 701 may be operable to carry out the operation in block 302, and the obtaining module 702 may be operable to carry out the operation in block 304. Optionally, the receiving module 701 and/or the obtaining module 702 may be operable to carry out more or less operations to implement the proposed methods according to the exemplary embodiments of the present disclosure.

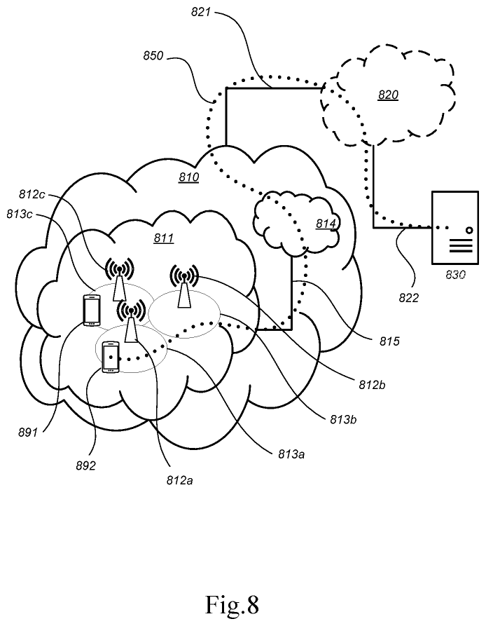

FIG. 8 is a block diagram illustrating a telecommunication network connected via an intermediate network to a host computer in accordance with some embodiments of the present disclosure.

With reference to FIG. 8, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first UE 881 located in a coverage area 813c is configured to wirelessly connect to, or be paged by, the corresponding base station 812c. A second UE 882 in a coverage area 813a is wirelessly connectable to the corresponding base station 812a. While a plurality of UEs 881, 882 are illustrated in this example, the disclosed embodiments are equally applicable to a situation where a sole UE is in the coverage area or where a sole UE is connecting to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. Connections 821 and 822 between the telecommunication network 810 and the host computer 830 may extend directly from the core network 814 to the host computer 830 or may go via an optional intermediate network 820. An intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 8 as a whole enables connectivity between the connected UEs 881, 882 and the host computer 830. The connectivity may be described as an over-the-top (OTT) connection 850. The host computer 830 and the connected UEs 881, 882 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, the base station 812 may not or need not be informed about the past routing of an incoming downlink communication with data originating from the host computer 830 to be forwarded (e.g., handed over) to a connected UE 881. Similarly, the base station 812 need not be aware of the future routing of an outgoing uplink communication originating from the UE 881 towards the host computer 830.

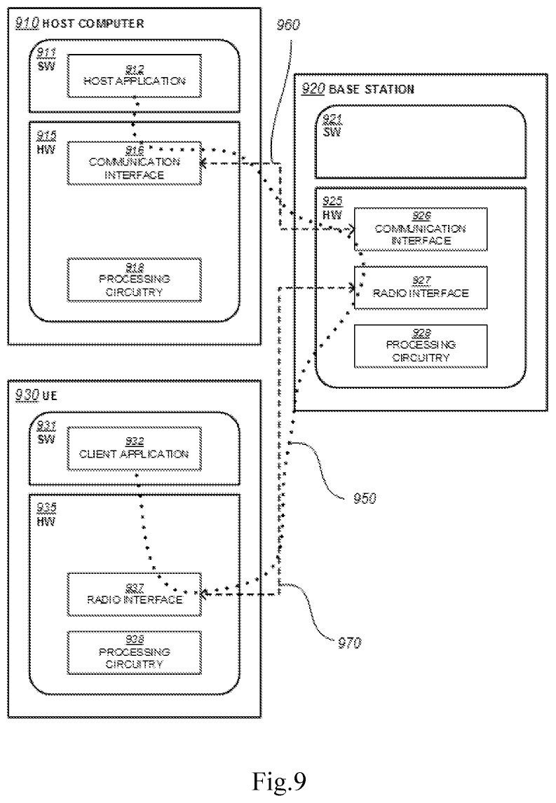

FIG. 9 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 9. In a communication system 900, a host computer 99 comprises hardware 915 including a communication interface 916 configured to set up and maintain a wired or wireless connection with an interface of a different communication device of the communication system 900. The host computer 99 further comprises a processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 99 further comprises software 911, which is stored in or accessible by the host computer 99 and executable by the processing circuitry 918. The software 911 includes a host application 912. The host application 912 may be operable to provide a service to a remote user, such as UE 930 connecting via an OTT connection 950 terminating at the UE 930 and the host computer 99. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 99 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with the UE 930 located in a coverage area (not shown in FIG. 9) served by the base station 920. The communication interface 926 may be configured to facilitate a connection 960 to the host computer 99. The connection 960 may be direct or it may pass through a core network (not shown in FIG. 9) of the telecommunication system and/or through one or more intermediate networks outside the telecommunication system. In the embodiment shown, the hardware 925 of the base station 920 further includes a processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes a processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 99. In the host computer 99, an executing host application 912 may communicate with the executing client application 932 via the OTT connection 950 terminating at the UE 930 and the host computer 99. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 99, the base station 920 and the UE 930 illustrated in FIG. 9 may be similar or identical to the host computer 930, one of base stations 912a, 912b, 912c and one of UEs 991, 992 of FIG. 9, respectively. This is to say, the inner workings of these entities may be as shown in FIG. 9 and independently, the surrounding network topology may be that of FIG. 9.

In FIG. 9, the OTT connection 950 has been drawn abstractly to illustrate the communication between the host computer 99 and the UE 930 via the base station 920, without explicit reference to any intermediary devices and the precise routing of messages via these devices. Network infrastructure may determine the routing, which it may be configured to hide from the UE 930 or from the service provider operating the host computer 99, or both. While the OTT connection 950 is active, the network infrastructure may further take decisions by which it dynamically changes the routing (e.g., on the basis of load balancing consideration or reconfiguration of the network).

Wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 950 between the host computer 99 and the UE 930, in response to variations in the measurement results. The measurement procedure and/or the network functionality for reconfiguring the OTT connection 950 may be implemented in software 911 and hardware 915 of the host computer 99 or in software 931 and hardware 935 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which the software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer 99's measurements of throughput, propagation times, latency and the like. The measurements may be implemented in that the software 911 and 931 causes messages to be transmitted, in particular empty or ‘dummy’ messages, using the OTT connection 950 while it monitors propagation times, errors etc.

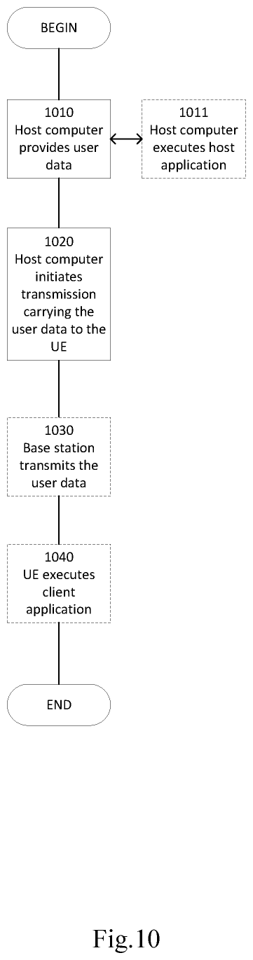

FIG. 10 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 10 will be included in this section. In step 1010, the host computer provides user data. In substep 1010 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

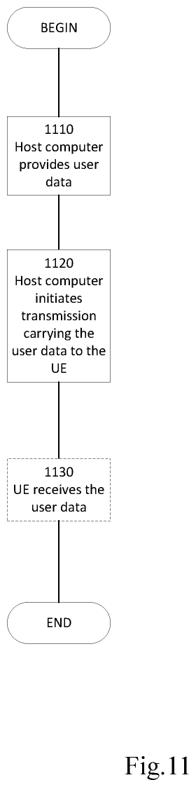

FIG. 11 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 11 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

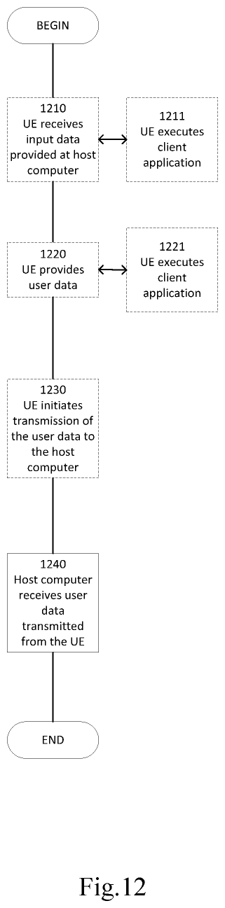

FIG. 12 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 12 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

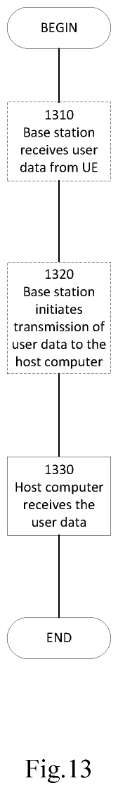

FIG. 13 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 13 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method at a network node, comprising:
determining a configuration of an Listen Before Talk, LBT, option selection; and
transmitting the determined configuration of the LBT option selection to at least one terminal device.

2. The method according to claim 1, wherein determining the configuration of LBT selection comprises:
determining the LBT option selection for at least one terminal device; or
determining a rule for selecting the LBT option by the terminal device.

3-17. (canceled)

18. A method at a terminal device, comprising:
receiving a configuration of an Listen Before Talk, LBT, option selection from at least one network node; and
obtaining the configuration of the LBT option selection.

19. The method according to claim 18, wherein obtaining the configuration of the LBT selection comprises:
obtaining the LBT option selection determined by the network node for the terminal device; or
obtaining a rule for selecting an LBT option by the terminal device.

20. The method according to claim 18, wherein an LBT option is selected for at least one of: a cell, an uplink transmission, a service, a channel.

21. The method according to claim 18, wherein the LBT option selection is determined based on at least one of: Buffer Status Report, BSR; Scheduling Request, SR; terminal device category information; terminal device capability information, bandwidth configuration information, bandwidth capacity information, channel sensing information.

22. The method according to claim 18, wherein the LBT option is selected for a user data transmission or a control information transmission.

23. The method according to claim 21, wherein the control information transmission comprises at least one of: Physical Random Access Channel, PRACH, transmission; Physical Uplink Control Channel, PUCCH, transmission; Sounding Reference Signal, SRS, transmission.

24. The method according to claim 18, wherein the LBT option comprises at least one of: wideband LBT, sub-band LBT.

25. The method according to claim 18, wherein the LBT option is selected the same as the LBT option of a latest uplink transmission.

26. The method according to claim 25, wherein the latest uplink transmission information is stored for a predetermined time.

27. The method according to claim 24, wherein the sub-band LBT is selected when any of below criteria is fulfilled:
Quality of Service, QoS, requirement for a data in a Logical Channel, LCH, is over a first threshold;
Media Access Control, MAC, Protocol Data Unit, PDU, comprises data from at least one of: Uplink Common Control Channel, UL-CCCH; Cell Radio Network Temporary Identifier, C-RNTI, Media Access Control, MAC, Control Element, CE; Buffer Status Report, BSR, CE; Power Headroom Report, PHR, CE; MAC CEs with QoS requirements over a second threshold;
scheduled data volume is below a third threshold;
scheduled grant occupies a portion of a whole schedulable bandwidth;
measured channel occupancy of a whole schedulable bandwidth is over a fourth threshold;
a ratio of high loaded sub-bands to all sub-bands occupied a whole schedulable bandwidth is over a fifth threshold, wherein the high loaded sub-bands are the sub-bands with measured channel occupancy of the sub-bands over a sixth threshold;
a wideband LBT failure occurs; and
information to be transmitted is the control information.

28. The method according to claim 24, wherein the wideband LBT is selected when none of below criteria is fulfilled:
Quality of Service, QoS, requirement for a data in a Logical Channel, LCH, is over a first threshold;
Media Access Control, MAC, Protocol Data Unit, PDU, comprises data from at least one of: Uplink Common Control Channel, UL-CCCH; Cell Radio Network Temporary Identifier, C-RNTI, Media Access Control, MAC, Control Element, CE; Buffer Status Report, BSR, CE; Power Headroom Report, PHR, CE; MAC CEs with QoS requirements over a second threshold;
scheduled data volume is below a third threshold;
scheduled grant occupies a portion of a whole schedulable bandwidth;
measured channel occupancy of a whole schedulable bandwidth is over a fourth threshold;
a ratio of high loaded sub-bands to all sub-bands occupied a whole schedulable bandwidth is over a fifth threshold, wherein the high loaded sub-bands are the sub-bands with measured channel occupancy of the sub-bands over a sixth threshold;
a wideband LBT failure occurs; and
information to be transmitted is the control information.

29. The method according to claim 24, wherein the wideband LBT is selected when
all sub-bands are determined to be available for an uplink transmission.

30. The method according to claim 18, further comprising:
transmitting a channel sensing information from the terminal device.

31. The method according to claim 21, wherein the channel sensing information comprises a received power strength per sub-band of a Bandwidth Part, BWP, and/or a total received power in the whole scheduled bandwidth.

32. The method according to claim 18, wherein receiving a configuration of an LBT option selection from at least one network node comprises receiving a configuration of LBT option selection from at least one network node via at least one of: System Information Block, SIB, signaling; Downlink Control Information, DCI, signaling; Media Access Control, MAC, Control Element, CE; Radio Resource Control, RRC, signaling.

33. The method according to claim 19, further comprising:
applying the selected LBT option after obtaining the LBT option selection determined by the network node, or after selecting the LBT option according to the rule received from the network node.

34. A terminal device, comprising:
one or more processors; and
one or more memories comprising computer program codes,
the one or more memories and the computer program codes configured to, with the one or more processors, cause the terminal device at least to:
receive a configuration of an Listen Before Talk, LBT, option selection from at least one network node; and
obtain the configuration of the LBT option selection.

35. The terminal device according to claim 34, wherein the terminal device obtains the configuration of the LBT selection by obtaining the LBT option selection determined by the network node for the terminal device, or obtaining a rule for selecting an LBT option by the terminal device.

36-38. (canceled)
